(19) United States
(12) Patent Application Publication
(10) Pub. No.: US 2006/0105180 A1
(43) Pub. Date: May 18, 2006

(54) System of layers for transparent substrates and coated substrate

(75) Inventors: Heinz Schicht, Bethau (DE); Herbert Schindler, Torgau (DE); Uwe Schmidt, Falkenberg (DE); Lars Ihlo, Pfluckuff (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 10/533,536

(22) PCT Filed: Nov. 7, 2002
(86) PCT No.: PCT/FR02/03816

§ 371 Date: Sep. 20, 2005

(51) Int. Cl. B32B 17/06; B32B 9/00; B32B 19/00

(52) U.S. Cl. 428/432; 428/426; 428/701; 428/702

(57) ABSTRACT

A multilayer system for the surface-coating of transparent substrates, particularly a low emission (Low-E) multilayer system for glass glazing, has at least one layer of mixed oxides produced by reactive sputtering from a metal target alloy. The layer of mixed oxides is made up of ZnO and TiO₂ at at least one of the oxides Al₂O₃, Ga₂O₃ and Sb₂O₃. It can act as an upper and/or lower antireflection layer, as a partial layer of an antireflection layer and/or as a top coat. Such a multilayer system is characterized by a high hardness and by very good resistance to a maritime environmental.

The invention relates to a multilayer system for transparent substrates, particularly for glass glazing, having at least one layer of mixed oxides made of ZnO and TiO₂, produced by reactive sputtering from a metal target alloy and at least one additional metal oxide.

Multilayer systems for glass glazing or other transparent substrates generally have, by way of functional layer, one or more silver layers, together with an upper antireflection layer and a lower antireflection layer made of metal oxide. Between the antireflection layers and the silver layer or the silver layers, there may be one or more additional layers which encourage the construction of the silver layer and/or which prevent disruptive elements from diffusing into the silver layer. In terms of multilayer systems, these may be low-emissivity [low-E] multilayer systems with a thermal insulation function and/or systems of this kind, having a solar protection function. Low-E systems are systems of neutral color with a high light transmission and a high transmission of the heat of the sun's radiation, with a view to saving energy within the construction. At the time of industrial manufacture, the multilayer systems are applied using the magnetically enhanced sputtering technique.

During transport and storage, the surface layers are exposed to mechanical stresses and, above all, in countries with a maritime climate, they are also exposed to aggressive chemical stresses. To improve the mechanical and chemical resistance capability of the multilayer system, it is known practice to produce one or more of the layers of oxides, particularly the upper antireflection layer or a partial layer of the upper antireflection layer, particularly the uppermost top coat, in the form of a mixed oxide layer, which means to say as a layer made up of one or more oxides. In this way, the hardness and the chemical resistance of the multilayer system can be enhanced.

A multilayer system with a layer of mixed oxides of the kind mentioned at the beginning is known from document EP-B1-0 304 234. In this case, the layer of mixed oxides is made up of at least two metal oxides, one of which is an oxide of Ti, Zr or Hf and the other of which is an oxide of Zn, Sn, In or Bi. The layer of mixed oxides may, in this instance, be produced by simultaneous sputtering from several different metal targets or from a target alloy containing the two metals.

How to produce the upper antireflection layer from two partial layers, the upper partial layer of which is made up of a mixed oxide based on zinc and aluminum, particularly having a spinel structure of the ZnAl₂O₄ type, in order to increase the mechanical and chemical resistance, is known from document EP-A1-0 922 681.

Document DE-C1-198 48 751 describes a multilayer system having a layer of mixed oxides which contains, with respect to the total proportion of metals, from 35 to 70% by weight of Zn, from 29 to 64.5% by weight of Sn and from 0.5 to 6.5% by weight of one or more of the elements Al, Ga, In, B, Y, La, Ge, Si, As, Sb, Bi, Ce, Ti, Zr, Nb and Ta.

Document U.S. Pat. No. 4,996,105 discloses multilayer systems with layers mixed oxides of the composition Sn₁₋ₓZnₓO_{y}. The layers of mixed oxides are produced by sputtering of a stoichiometric zinc-tin alloy for which the Zn:Sn ratio is 1.1 at %.

Documents EP-A1-0 464 789 and EP-A1-0 751 099 also describe multilayer systems with antireflection layers made of mixed oxides. In this case, the layers of mixed oxides based on ZnO or SnO contain an addition of Sn, Al, Cr, Ti, Si, B, Mg or Ga.

The multilayer system described in document EP-A1-0 593 883 in which the upper antireflection layer is produced in the form of a triple non-metallic layer made up of two oxide layers zinc and one titanium oxide layer arranged between the latter two layers, which have been sputtered one after the other, also belongs to the prior art. The triple layer may be covered with an additional top coat of titanium oxide. The authors of the document are assuming that, during the procedure of depositing the coating, a zinc titanate layer forms between the zinc oxide layers and the titanium oxide layer, this zinc titanate layer lying in the subnanometric domain and enhancing the protection against environmental influences. From the analytical standpoint, it is not, however, possible to detect intermediate zinc titanate layers in the case of this multilayer system.

In the case of industrial coating plants, there are difficulties associated with sputtering zinc titanate layers from Zn—Ti target alloys. Quite especially, at the start of the sputtering process, deposits which are insulating from the electrical standpoint actually occur in the case of this material at the target and on parts of the sputtering chamber and this has the effect that defective products are formed and thus there is some scrapping during production.

The fundamental object of the invention is to further improve the multilayer systems having at least one layer of mixed oxides made of ZnO and of TiO₂, on the one hand, as regards their hardness and their chemical resistance and, on the other hand, to avoid the difficulties which arise during the process of sputtering Zn—Ti alloys.

This object is achieved according to the invention by virtue of the characteristics of claim 1.

The functional layer of the multilayer system according to the invention is preferably a layer of metallic nature, chosen particularly from silver, gold, and platinum and advantageously silver.

The layer of mixed oxides made up according to the invention preferably has a thickness from 2 to 20 nm and may be situated within the multilayer system, theoretically at any point. However, by way of partial layer of the upper antireflection layer, it appropriately forms the actual top coat of the multilayer system. The lower antireflection layer and the other partial layer of the upper antireflection layer may be made up for example of SnO₂, ZnO, TiO₂ and/or Bi₂O₃.

In one preferred embodiment of the invention, ZnO and TiO₂ are present in the layer of mixed oxides in a molar ratio of the order of 1:1 to 2:1, particularly molar ratios of 1:1 or 2:1, which means either ZnTiO₃ or Zn₂TiO₄. The proportion of the oxides Al₂O₃, Ga₂O₃, and/or Sb₂O₃ in the layer of mixed oxides is preferably from 0.5 to 8% by weight.

The target alloys, by virtue of which layers of mixed oxides of this kind can be produced, correspondingly exhibit from 90 to 40% by weight of Zn, from 10 to 60% by weight of Ti and from 0.5 to 8% by weight of one or more of the metals Al, Ga and Sb.

In addition, one subject of the invention is a transparent substrate coated with a multilayer system as described hereinabove. The substrate is advantageously glazing made up of at least one sheet of glass or of plastic.

In that which follows, three comparative examples of multilayer systems with layers of mixed oxides produced according to the prior art are offered for comparison with an exemplary embodiment according to the invention. The multilayer systems in this instance, for all the examples, have the same sequence of layers and the layer of mixed oxides in all cases forms the top coat.

In order to evaluate the properties of the layers, eight different tests were performed in all the examples. These tests were:

1. The scratch resistance test

In this instance, a needle loaded with a weight was drawn at a defined speed across the layer. The weight for which scratches became visible gave a measure of the hardness in terms of scratching.

2. The Taber test

The layer was stressed using a friction roller of defined roughness under a defined application pressure and for a predetermined number of revolutions. The attacked layer was evaluated microscopically. The portion of layer not destroyed is given as a %.

3. The Erichsen washing test in accordance with ASTM 2486

Visual evaluation of the scratches after 1000 strokes back and forth.

4. Condensate resistance test in accordance with DIN 50021

Visual evaluation of the changes to the layer after 240 hours.

5. Diffracted light measurement

After the condensate resistance test, a Gardner measurement apparatus for measuring diffracted light was used to measure the proportion of diffracted light resulting from the changes to the layer. The proportion of light diffracted is given as a %.

6. EMK test

This test is described in publication Z. Silikattechnik 32 (1981), page 216. It provides an estimate relating to the passivation quality of the top coat on top of the silver layer and to the corrosion behavior of the Ag layer. The lower the potential difference (in mV) between the multilayer system and the reference electrode, the better the quality of the layer.

7. Salt fog test in accordance with DIN 500021/Visual evaluation of the changes to the layer.

8. Environmental test in accordance with DIN 52344/Visual evaluation of the changes to the layer.

In that which follows, these tests will be referred to by their numbering.

### COMPARATIVE EXAMPLE 1

An industrial-scale continuous magnetron plant was used to apply, to float glass glazing 4 mm thick, a multilayer system according to the prior art having the following sequence of layers:

Glass—20 nm of SnO₂—17 nm of ZnO—11 nm of Ag—2 nm of CrNi—38 nm of SnO₂—2 nm of ZnₓSn_{y}Sb_{z}Oₙ.

The layer of mixed oxides forming the top coat was applied by sputtering in accordance with document DE-C1-198 48 751, from a metal target with a composition of 68 wt % Zn, 30 wt % Sn and 2 wt % Sb, in an Ar/O₂ working gas atmosphere.

Tests 1 to 8 carried out on this multilayer system gave the following results:

1. 30-175 g

2. 87%

3. 11 small scratches

4. red spots

5. 0.23%

6. 111 mV

7. spot defects after 24 hours

8. matt areas after 24 hours

### COMPARATIVE EXAMPLE 2

The same coating plant was used to deposit the same sequence of layers on float glass glazing 4 mm thick, the only difference being that the top coat of mixed oxides was replaced by a stoichiometric mixed oxide which was applied by sputtering in accordance with document EP-A1-0 922 681 from a target metal alloy with a composition of 55 wt % Zn and 45 wt % Al. The sequence of layers was as follows:

Glass—20 nm of SnO₂—17 nm of ZnO—11 nm of Ag—2 nm of CrNi—38 nm of SnO₂—3 nm of ZnAl₂O₄.

The tests yielded the following layer evaluation:

1. 49-119 g

2. 83-90%

3. no scratches

4. one spot defect

5. 0.26%

6. 190 mV

7. spot defects after 24 hours

8. spots of corrosion after 24 hours

### COMPARATIVE EXAMPLE 3

For a layer construction identical in theory to the preceding examples, a top coat of mixed oxides of ZnO and TiO₂ was applied, with the layer of mixed oxides containing 3 at % of Ti with respect to its total metal content. A top coat of this kind is described in document EP-A1-0 751 099. It was applied from a target with a composition of 97 at % Zn and 3 at % Ti using the same sputtering plant in an Ar/O₂ working gas reactive atmosphere and led to a nonstoichiometric layer of mixed oxides with the qualitative composition ZnO/Zn₂TiO₄. The multilayer system had the following structure:

Glass—20 nm of SnO₂—17 nm of ZnO—11 nm of Ag—2 nm of CrNi—38 nm of SnO₂—3 nm of ZnO/Zn₂TiO₄.

During the depositing of the layers in reactive sputtering operation, substantial problems occurred after operating with this target material for approximately 2 days in the corresponding sputtering chamber, which meant that the process had to be interrupted.

This multilayer system had the following properties.

1. 112-193 g

2. 90-91%

3. 2 medium scratches and 10 small scratches

4. red spots

5. 0.33%

6 130 mV

7. spot defects after 24 hours

8. spots of corrosion after 24 hours

### Exemplary embodiment

Just as in the comparative examples, the layer according to the invention was applied by sputtering to the same sequence of layers, by way of a top coat. This was done from a target with a composition of 71 wt % Zn, 27 wt % Ti and 2 wt % Al.

For an Ar/O₂ ratio of 70:30 in the working gas, it was possible to deposit an essentially stoichiometric layer of Zn₂TiO₄ with a high surface smoothness. The sputtering operation was performed without any problem.

The multilayer system had the following structure:

Glass—20 nm of SnO₂—17 nm of ZnO—11 nm of Ag—2 nm of CrNi—38 nm of SnO₂—3 nm of Zn₂TiO₄:Al

The tests yielded the following properties for this multilayer system:

1. 136-241

2. 91-92%

10 3. 1 medium scratch and 3 small scratches

4. no defect after 360 hours

5. 0.25%

6. 60 mV

7. no defect after 48 hours, first defects after 55 hours

8. no defect after 24 hours, first defects after 48 hours.

The table which follows summarizes once again the results of the tests of the four examples in order to provide an overview:

| | Comparative | Comparative | Comparative | Exemplary |
|---|---|---|---|---|
| | example 1 | example 2 | example 3 | embodiment |
| Scratch test | 30-175 g | 49-119 g | 112-193 g | 136-241 g |
| Taber test | 87% | 83-90% | 90-91% | 91-92% |
| Erichsen | 11 small | no scratches | 2 medium | 1 medium |
| washing test | scratches | | scratches and | scratch and |
| | | | 10 small | 3 small |
| | | | scratches | scratches |
| Condensate | red spots | one spot | red spots | no defects |
| resistance | | defect | | after |
| test | | | | 360 hours |
| Diffracted | 0.23% | 0.26% | 0.33% | 0.25% |
| light | | | | |
| measurement | | | | |
| EMK test | 111 mV | 190 mV | 130 mV | 60 mV |
| Salt fog test | spot defects | spot defects | spot defects | first defects |
| | after 24 hours | after 24 hours | after 24 hours | after 55 hours |
| Climate change | matt regions | spots of | spots of | first defects |
| test | after 24 hours | corrosion | corrosion | after 48 hours |
| | | after 24 hours | after 24 hours | |

Comparison with the results of the examples according to the prior art shows that a layer of mixed oxides Zn₂TiO₄:Al in the multilayer system leads to the following notable properties:

sputtering can be performed without any problem

the hardness of the layer is high

there is very good electrochemical passivation

there is high resistance to moisture and electrolytes such as a solution of NaCl for example, and this makes it possible to conclude that there is very good resistance to a marine environment.

The foregoing series of examples must not be interpreted as having a restrictive nature and good results may also be seen with a layer of mixed oxides in which the aluminum is replaced with gallium or antimony, or a combination of these elements, it being possible for this layer to be placed right on the surface of the multilayer system or as inner or subjacent layers.

1. A multilayer system for transparent substrates, comprising at least one functional layer and at least one layer of mixed oxides made of ZnO and TiO₂ and at least one additional oxide, produced by reactive sputtering from a metal target alloy, wherein the additional oxide is selected from the group consisting of Al₂O₃, Ga₂O₃ Sb₂O₃ and mixtures thereof.

2. The multilayer system as claimed in claim 1, wherein ZnO and TiO₂ are present in the layer of mixed oxides in a molar ratio of the order of 1:1 to 2:1.

3. The multilayer system as claimed in claim 2, wherein ZnO and TiO₂ are present in the layer of mixed oxides essentially in molar ratios of 1:1 or 2:1.

4. The multilayer system as claimed in claim 1 wherein the proportion of oxides Al₂O₃, Ga₂O₃, and/or Sb₂O₃ in the layer of mixed oxides is from 0.5 to 8% by weight.

5. The multilayer system as claimed in claim 1 wherein the thickness of the layer of mixed oxides is from 2 to 20 nm.

6. The multilayer system as claimed in claim 1 wherein the layer of mixed oxides is the lower and/or upper antireflection layer of a low-emission [low-E] multilayer system exhibiting one or more functional layers made of silver.

7. The multilayer system as claimed in claim 1 wherein the layer of mixed oxides is a partial layer of the upper and/or lower antireflection layer of a low-E multilayer system exhibiting one or more functional layers made of silver.

8. The multilayer system as claimed in claim 1 comprising a structure as follows: Substrate—SnO₂—ZnO—Ag—CrNi—SnO₂—Zn₂TiO₄:AI.

9. The multilayer system as claimed in claim 1 wherein the layer of mixed oxides is produced from a metal target alloy containing from 90 to 40% by weight of Zn, from 10 to 60% by weight of Ti and from 0.5 to 8% by weight of one or more of the metals Al, Ga and Sb.

10. The multilayer system as claimed in claim 9, wherein the target alloy for the production of the layer of mixed oxides contains 71% by weight of Zn, 27% by weight of Ti and 2% by weight of Al.

11. The multilayer system as claimed in claim 9, wherein the target alloy for producing the layer of mixed oxides contains 56% by weight of Zn, 42% by weight of Ti and 2% by weight of Al.

12. A transparent substrate, coated with a multilayer system as claimed in claim 1.

13. The multilayer system for transparent substrates as claimed in claim 1 wherein the transparent substrate is glass glazing.

14. A glazing coated with a multilayer system as claimed in claim 1.
